(19) United States
(12) Patent Application Publication
(10) Pub. No.: US 2015/0149223 A1
(43) Pub. Date: May 28, 2015

(54) MOTIVATION MANAGEMENT DEVICE, MOTIVATION MANAGEMENT METHOD, AND COMPUTER-READABLE RECORDING MEDIUM

(71) Applicant: NEC Corporation, Minato-ku, Tokyo (JP)

(72) Inventors: Takao Shime, Tokyo (JP); Daishi Kato, Tokyo (JP); Satoru Ooga, Tokyo (JP)

(21) Appl. No.: 14/406,296

(22) PCT Filed: Jun. 12, 2013
(86) PCT No.: PCT/JP2013/066199

§ 371 Date: Dec. 8, 2014

(30) Foreign Application Priority Data
Jun. 19, 2012 (JP) 2012-137422

(51) Int. Cl. G06Q 10/06

(52) U.S. Cl. CPC G06Q 10/063
USPC 705/7.11

(57) ABSTRACT

A motivation management device 1 includes: a motivator calculation unit 2 that acquires positional information of a target employee and other employees and utterance information of the target employee and the other employees, and calculates a degree of a motivator as a factor of a motivation of the target employee, based on the positional information and the utterance information; a motivation calculation unit 3 that calculates a degree of motivation of the target employee; and a relevance degree calculation unit 4 that calculates a relevance degree between the degree of the motivator and the degree of the motivation. The motivation management device 1 can effectively improve a motivation of an employee.

### TECHNICAL FIELD

The present invention relates to a motivation management device and a motivation management method capable of managing the motivation of employees, and a computer-readable recording medium in which a program for realizing these is recorded.

### BACKGROUND ART

Recently, it is becoming a common idea that, when evaluating a company's value, it is important to evaluate not only the tangible assets of a company but also intangible assets of the company. Accordingly, it is necessary for a company to consider not only tangible assets but also intangible assets in order to increase the company value.

Examples of the intangible assets include human resources that include factors such as an employee motivation for a job. Accordingly, it is important to improve an employee motivation, in view of intangible assets.

As a technique for improving such an employee motivation, for example, a system described in Patent Document 1 analyzes a daily report input by an employee, thereby obtaining an indexed degree of a decrease in motivation of the employee, and transmits information notifying that an individual interview is to be performed, to the employee at the appropriate time. Based on the notification information, an individual interview is performed with the employee, so that the employee motivation that has decreased can be recovered.

### CITATION LIST

### Patent Document

Patent Document 1: JP 2006-190162A

### SUMMARY OF INVENTION

### Technical Problem

Incidentally, a motivation involves various factors referred to as motivators, and a motivator that affects improvement of the motivation (hereinafter, referred to as an important motivator) varies from employee to employee. Accordingly, if an interview with an employee is performed without identifying an important motivator of that employee, the motivation of the employee may not be improved. Thus, in order to effectively improve the motivation of each employee, it is very important to identify an important motivator of that employee.

It is an object of the present invention to provide a motivation management device, a motivation management method, and a computer-readable recording medium capable of identifying, for each employee, a motivator that can effectively improve the motivation of that employee.

### Solution to Problem

In order to achieve the above-described object, an aspect of the present invention is directed to a motivation management device, including:

a motivator calculation unit that acquires positional information of a target employee and other employees and utterance information of the target employee and the other employees, and calculates a degree of a motivator as a factor of a motivation of the target employee, based on the positional information and the utterance information;

a motivation calculation unit that calculates a degree of motivation of the target employee; and

a relevance degree calculation unit that calculates a relevance degree between the degree of the motivator and the degree of the motivation.

Furthermore, in order to achieve the above-described object, an aspect of the present invention is directed to a method for managing a motivation of a target employee, including:

a step (a) of acquiring positional information of the target employee and other employees and utterance information of the target employee and the other employees;

a step (b) of calculating a degree of a motivator as a factor of the motivation of the target employee, based on the positional information and the utterance information;

a step (c) of calculating a degree of motivation of the target employee; and

a step (d) of calculating a relevance degree between the degree of the motivator and the degree of the motivation.

Furthermore, in order to achieve the above-described object, an aspect of the present invention is directed to a computer-readable recording medium in which a program for causing a computer to manage a motivation of a target employee is recorded, the program containing commands for causing the computer to execute:

a step (a) of acquiring positional information of the target employee and other employees and utterance information of the target employee and the other employees;

a step (b) of calculating a degree of a motivator as a factor of the motivation of the target employee, based on the positional information and the utterance information;

a step (c) of calculating a degree of motivation of the target employee; and

a step (d) of calculating a relevance degree between the degree of the motivator and the degree of the motivation.

### Advantageous Effects of Invention

As described above, according to the present invention, it is possible to identify, for each employee, a motivator that can effectively improve the motivation of that employee.

### BRIEF DESCRIPTION OF DRAWINGS

FIG. 1 is a block diagram showing the configuration of a motivation management device according to an embodiment of the present invention.

FIG. 2 is a flowchart showing an operation of the motivation management device according to the embodiment of the present invention.

FIG. 3 is a flowchart showing an exemplary operation in which the motivation management device according to the embodiment of the present invention calculates a job management degree.

FIG. 4 is a flowchart showing an exemplary operation in which the motivation management device according to the embodiment of the present invention calculates an appraisal/evaluation degree.

FIG. 5 is a flowchart showing another exemplary operation in which the motivation management device according to the embodiment of the present invention calculates an appraisal/evaluation degree.

FIG. 6 is a flowchart showing an exemplary operation in which the motivation management device according to the embodiment of the present invention calculates a companionship degree.

FIG. 7 is a flowchart showing another exemplary operation in which the motivation management device according to the embodiment of the present invention calculates a companionship degree.

FIG. 8 is a flowchart showing another exemplary operation in which the motivation management device according to the embodiment of the present invention calculates a companionship degree.

FIG. 9 is a block diagram showing an exemplary computer that realizes the motivation management device according to the embodiment of the present invention.

### DESCRIPTION OF EMBODIMENT

### Embodiment

Hereinafter, a motivation management device, a motivation management method, and a program in an embodiment of the present invention will be described with reference to the drawings.

Motivation Management Device

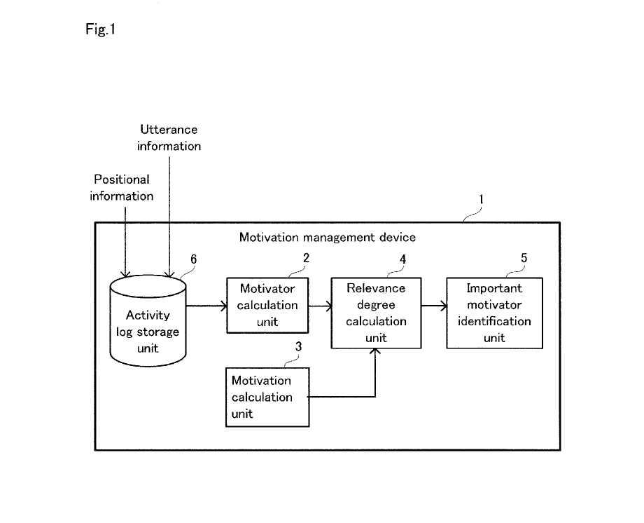

First, the configuration of a motivation management device in this embodiment will be described with reference to FIG. 1. FIG. 1 is a functional block diagram showing the configuration of the motivation management device according to this embodiment of the present invention.

As shown in FIG. 1, a motivation management device 1 in this embodiment includes a motivator calculation unit 2, a motivation calculation unit 3, and a relevance degree calculation unit 4.

The motivator calculation unit 2 acquires positional information of an employee targeted for evaluation (hereinafter, referred to as a target employee) and employees other than the target employee (hereinafter, referred to as other employees). Furthermore, the motivator calculation unit 2 acquires utterance information of the target employee and the other employees.

Then, the motivator calculation unit 2 calculates a degree (level) of a motivator as a factor of a motivation of the target employee, based on the acquired positional information and utterance information. Note that a degree of a motivator indicates how high or low the motivator is, the motivator being a factor of a motivation. Examples of the motivator include a job management degree, an appraisal/evaluation degree, and a companionship degree, which will be described later.

The motivation calculation unit 3 calculates a degree (level) of motivation of the target employee. The relevance degree calculation unit 4 calculates a relevance degree between the degree of the motivator and the degree of the motivation. Note that a degree of motivation indicates how high or low the motivation is.

In this manner, the motivation management device 1 can calculate a relevance degree between the degree of the motivation and the degree of the motivator, using the relevance degree calculation unit 4. Accordingly, with the motivation management device 1, it is possible to see how much a motivator whose degree has been calculated by the motivator calculation unit 2 affects the motivation of the target employee.

As a result, a motivator that greatly affects the motivation of the target employee, that is, an important motivator of the target employee can be identified. If an important motivator of the target employee can be identified in this manner, for example, a target employee's supervisor can perform an interview or the like with the target employee in consideration of the important motivator of the target employee, so that the motivation of the target employee can be effectively improved.

Hereinafter, the configuration of the motivation management device 1 according to this embodiment will be more specifically described with reference to the drawings.

As shown in FIG. 1, in this embodiment, the motivation management device 1 further includes an important motivator identification unit 5 and an activity log storage unit 6, in addition to the motivator calculation unit 2, the motivation calculation unit 3, and the relevance degree calculation unit 4 described above.

The activity log storage unit 6 stores utterance information of the target employee and the other employees. Furthermore, the activity log storage unit 6 also stores positional information of the target employee and the other employees. The activity log storage unit 6 may be provided in a storage area of a storage device included in the motivation management device 1 as in this embodiment, or may be provided in a storage area of an external storage device that is connected to the motivation management device 1.

The utterance information of the target employee or the other employees may be, for example, acquired from voice input from a wearable microphone attached to each employee, or may be acquired from voice input to a microphone or the like installed in the workplace.

The utterance information contains a time and date, an utterance content given at the time and date, and an identifier number for identifying an employee who gave that utterance. Furthermore, the voice input to a wearable microphone or the like is converted into text data by voice recognition processing, and is then stored in the activity log storage unit 6 as the utterance information.

Furthermore, the positional information of an employee stored in the activity log storage unit 6 may be acquired by analyzing video captured by an image capturing device installed in the workplace, or may be acquired from a GPS system attached to the employee. The positional information contains a time and date, a position of an employee at the time and date, and an identifier number for identifying the employee.

Note that the utterance information and the positional information stored in the activity log storage unit 6 may be associated with each other based on the time and date, and the identifier number of the employee contained in these pieces of information. Accordingly, for example, it is possible to see when, where, and what kind of utterance was given by whom, based on the utterance information and the positional information stored in the activity log storage unit 6.

The motivator calculation unit 2 in this embodiment acquires the utterance information of the target employee and the other employees, and further acquires the positional information of the target employee and the other employees, from the activity log storage unit 6. Then, the motivator calculation unit 2 calculates a job management degree, an appraisal/evaluation degree, and a companionship degree, as the degree of the motivator, based on the acquired utterance information and positional information.

The job management degree is a degree indicating how much the target employee understands his or her job. The job management degree increases, as the target employee thinks that he or she understands his or her job more.

The appraisal/evaluation degree is a degree indicating how highly the target employee is appraised or evaluated. The appraisal/evaluation degree increases, as the target employee thinks that he or she is more highly appraised or evaluated by the others.

The companionship degree is a degree indicating how well the target employee relates to the others in the workplace. The companionship degree increases, as the target employee thinks that he or she relates better to the others.

The motivation calculation unit 3 in this embodiment acquires a result of a questionnaire answered by the target employee, and calculates a degree of motivation of the target employee based on the questionnaire result. Note that the motivation calculation unit 3 may acquire a degree of motivation calculated in advance based on the questionnaire result, and may use this value without any processing as the degree of motivation of the target employee.

The relevance degree calculation unit 4 acquires the degree of each motivator calculated by the motivator calculation unit 2, from the motivator calculation unit 2, and further acquires the degree of the motivation calculated by the motivation calculation unit 3, from the motivation calculation unit 3.

Then, the relevance degree calculation unit 4 calculates, for each motivator, a relevance degree indicating how deeply the degree of the motivator and the degree of the motivation are related to each other. Specifically, the relevance degree calculation unit 4 calculates a relevance degree between the job management degree and the degree of the motivation, a relevance degree between the appraisal/evaluation degree and the degree of the motivation, and a relevance degree between the companionship degree and the degree of the motivation. As the relevance degree, for example, a correlation coefficient between the degree of the motivator and the degree of the motivation may be used. Examples of the correlation coefficient include a Pearson product-moment correlation coefficient.

The important motivator identification unit 5 acquires, for each motivator, the relevance degree between the degree of the motivator and the degree of the motivation, from the relevance degree calculation unit 4. Specifically, the important motivator identification unit 5 acquires the relevance degree between the job management degree and the degree of the motivation, the relevance degree between the appraisal/evaluation degree and the degree of the motivation, and the relevance degree between the companionship degree and the degree of the motivation. Then, the important motivator identification unit 5 identifies an important motivator that greatly affects the motivation, from among the motivators, based on the relevance degrees.

For example, the important motivator identification unit 5 acquires correlation coefficients between the degrees of the respective motivators and the degree of the motivation calculated by the relevance degree calculation unit 4, and identifies, as the important motivator of the target employee, a motivator with the highest correlation coefficient. Alternatively, the important motivator identification unit 5 may identify, as the important motivator, a motivator with its correlation coefficient being a predetermined threshold or higher, as well as a motivator with the highest correlation coefficient.

Operation of the Motivation Management Device

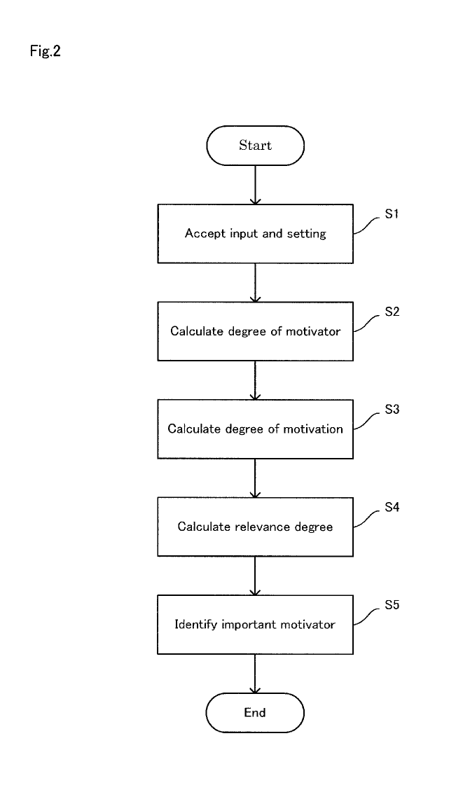

Next, an operation of the motivation management device in the embodiment of the present invention will be described with reference to FIG. 2, together with FIG. 1 as appropriate. In this embodiment, the motivation management method is performed by operating the motivation management device, and, thus, the following description of an operation of the motivation management device may be taken as a description of the motivation management method in this embodiment.

FIG. 2 is a flowchart showing an operation of the motivation management device according to the embodiment of the present invention.

As shown in FIG. 2, the motivator calculation unit 2 first accepts input of information for identifying a target employee targeted for evaluation, and further accepts setting of an evaluation target period (step S1). For example, the motivator calculation unit 2 accepts input of information for identifying a target employee A, and further accepts setting of an evaluation target period for the target employee A as lasting from Apr. 1, 2012 to Mar. 31, 2013.

Next, the motivator calculation unit 2 acquires the utterance information and the positional information of the target employee from the activity log storage unit 6, and calculates the degree of each motivator of the target employee based on the acquired utterance information and positional information (step S2). For example, in step S2, the motivator calculation unit 2 divides the target period into a plurality of unit periods, and calculates the degree of each motivator for each unit period. Specifically, the motivator calculation unit 2 divides the target period lasting for one year from Apr. 1, 2012 to Mar. 31, 2013, into 12 unit periods each lasting for one month, and calculates the degree of each motivator for each month. Note that the unit period may be set in advance, or setting thereof may be accepted by the motivator calculation unit 2 in step S1 above.

Furthermore, the motivator calculation unit 2 associates the utterance information and the positional information acquired in step S2 with each other, thereby analyzing when, where, and what kind of utterance was given by whom. Then, the motivator calculation unit 2 calculates a job management degree, an appraisal/evaluation degree, and a companionship degree, as degrees of motivators, based on the analysis result. The process in which the motivator calculation unit 2 calculates the degree of each motivator will be described later in detail.

Next, the motivation calculation unit 3 calculates a degree of motivation of the target employee (step S3). For example, in a manner similar to that by the motivator calculation unit 2, the motivation calculation unit 3 in step S3 divides the target period into a plurality of unit periods, and calculates a degree of motivation of the target employee for each unit period. It is preferable that the unit period set by the motivation calculation unit 3 is the same as the unit period set by the motivator calculation unit 2. Specifically, the motivation calculation unit 3 divides the target period lasting for one year from Apr. 1, 2012 to Mar. 31, 2013, into 12 unit periods each lasting for one month, and calculates a degree of motivation for each month.

For example, the motivation calculation unit 3 acquires a result of a questionnaire answered by the target employee in each month, and calculates a degree of motivation of the target employee for each month based on the acquired result. Specifically, for example, the target employee answers the following questionnaire entries on a 5-point scale.

“Are you trying to improve your job performance?”
“Are you fine?”
“Are you enjoying your job?”
“Are your proud of your current job?”

Then, the motivation calculation unit 3 acquires answers on a 5-point scale to the questionnaire entries, and calculates an average value of the answers as the degree of the motivation of the target employee. Note that the questionnaire entries are listed on questionnaire sheets and distributed to target employees, but there is no specific limitation on the distribution method.

In this embodiment, the motivation calculation unit 3 calculates a degree of motivation after the motivator calculation unit 2 calculates a degree of each motivator, but there is no specific limitation on the calculation order. For example, the motivator calculation unit 2 may calculate a degree of each motivator after the motivation calculation unit 3 calculates a degree of motivation. Alternatively, the motivation calculation unit 3 may calculate a degree of motivation while the motivator calculation unit 2 is calculating a degree of each motivator.

Next, the relevance degree calculation unit 4 calculates, for each motivator, a relevance degree between the degree of the motivator and the degree of the motivation (step S4).

Specifically, the relevance degree calculation unit 4 acquires the degree of each motivator in each month, from the motivator calculation unit 2, and further acquires the degree of motivation in each month, from the motivation calculation unit 3. Then, the relevance degree calculation unit 4 calculates, for each motivator, a relevance degree between the degree of the motivator and the degree of the motivation.

That is to say, the relevance degree calculation unit 4 calculates, for each motivator, a correlation coefficient between the degree of the motivator and the degree of the motivation, from a change in the degree of the motivator in each month and a change in the degree of the motivation in each month. The relevance degree calculation unit 4 obtains the correlation coefficient, as the relevance degree between the degree of each motivator and the degree of the motivation.

Next, the important motivator identification unit 5 acquires the relevance degree between each motivator and the motivation, from the relevance degree calculation unit 4, and identifies an important motivator based on the relevance degrees (step S5).

Specifically, the important motivator identification unit 5 identifies, as the important motivator of the target employee, a motivator with the highest relevance degree, that is, a motivator with the highest correlation coefficient, based on the relevance degree between the degree of each motivator and the degree of the motivation acquired from the relevance degree calculation unit 4.

Alternatively, the important motivator identification unit 5 may use methods other than those described above to identify, as the important motivator of the target employee, a motivator with its relevance degree, that is, with its correlation coefficient with the degree of the motivation being a predetermined threshold or higher. Note that an experiment may be performed in advance to check the smallest value of the correlation coefficient that affects the motivation of the target employee, and the threshold may be set based on the experimental result.

If the motivation management device operates as described above, an important motivator that greatly affects the motivation of the target employee can be identified. For example, the motivation management device 1 notifies a target employee's supervisor and the like of the important motivator of the target employee. Accordingly, the target employee's supervisor can perform an interview or the like with the target employee in consideration of his or her important motivator, so that the motivation of the employee can be effectively improved.

Process that Calculates Degree of Each Motivator

Hereinafter, a specific process in which the motivator calculation unit 2 calculates the degree of each motivator in step S2 above will be described with reference to the drawings.

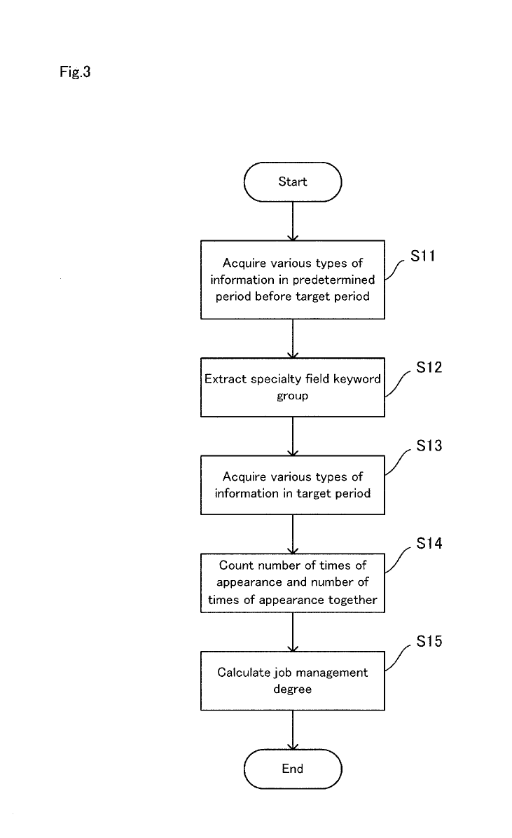

First, the process in which the motivator calculation unit 2 calculates a job management degree will be specifically described with reference to FIG. 3.

FIG. 3 is a flowchart showing an exemplary operation in which the motivation management device according to the embodiment of the present invention calculates a job management degree.

As shown in FIG. 3, the motivator calculation unit 2 first acquires positional information of the target employee and utterance information and positional information of the other employees in a predetermined period before the evaluation target period, from the activity log storage unit 6 (step S11). For example, the motivator calculation unit 2 accepts a setting that the evaluation target period is from Apr. 1, 2012 to Mar. 31, 2013, and sets the unit period to one month. In this case, for example, the motivator calculation unit 2 acquires various types of information in a period from Apr. 1, 2011 to Mar. 31, 2012 as the predetermined period before the evaluation target period, from the activity log storage unit 6.

Next, the motivator calculation unit 2 extracts a specialty field keyword group from the utterance information and the positional information acquired in step S11 (step S12). Specifically, the motivator calculation unit 2 extracts, as the specialty field keyword group, a keyword that appeared together with a request term uttered by the other employees to the target employee the number of times (the number of times of appearance together) that is a threshold or more.

Note that an experiment may be performed in advance, and the threshold may be set based on the experimental result. For example, an experiment may be performed to check whether or not the target employee thinks that he or she is good at a task if the number of times that the target employee was given a request to perform the same task or the like and performed that task is a predetermined number of times or more, and the threshold may be set based on the experimental result.

The request term is a term used when requesting to perform a task, and examples thereof include “please” and the like. For example, the motivator calculation unit 2 extracts, as the specialty field keyword group, a keyword that appeared together with a request term 20 times or more, but there is no limitation to this.

Next, the motivator calculation unit 2 acquires positional information of the target employee and utterance information and positional information of the other employees in the evaluation target period from Apr. 1, 2012 to Mar. 31, 2013, from the activity log storage unit 6 (step S13).

Then, the motivator calculation unit 2 counts the number of times A of appearance of the request term uttered to the target employee in each unit period (in each month) of the evaluation target period, based on the various types of information acquired in step S13 (step S14).

Furthermore, in step S14, the motivator calculation unit 2 counts the number of times B of appearance of a keyword contained in the specialty field keyword group together with the request term uttered to the target employee in each unit period, based on the various types of information acquired in step S13.

Then, the motivator calculation unit 2 calculates a job management degree C., which is a value (B/A) obtained by dividing the number of times B of appearance of the keyword together with the request term by the number of times A of appearance of the request term in each month that is the unit period (step S15). In this manner, the motivator calculation unit 2 calculates a job management degree for each month of the target period from Apr. 1, 2012 to Mar. 31, 2013.

Next, the process in which the motivator calculation unit 2 calculates an appraisal/evaluation degree will be specifically described.

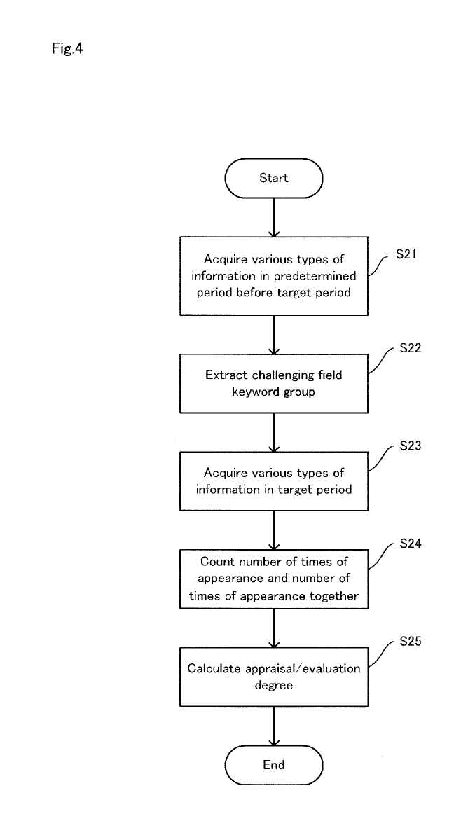

FIG. 4 is a flowchart showing an exemplary operation in which the motivation management device according to the embodiment of the present invention calculates an appraisal/evaluation degree.

As shown in FIG. 4, the motivator calculation unit 2 first acquires positional information of the target employee and utterance information and positional information of the other employees in a predetermined period before the evaluation target period, from the activity log storage unit 6 (step S21). For example, the motivator calculation unit 2 accepts a setting that the evaluation target period is from Apr. 1, 2011 to Mar. 31, 2012, and sets the unit period to one month. In this case, for example, the motivator calculation unit 2 acquires the utterance information and the positional information in a period from Apr. 1, 2011 to Mar. 31, 2012 as the predetermined period before the evaluation target period, from the activity log storage unit 6.

Next, the motivator calculation unit 2 extracts a challenging field keyword group from the utterance information and the positional information acquired in step S21 (step S22). Specifically, the motivator calculation unit 2 extracts, as the challenging field keyword group, a keyword that appeared together with a request term uttered by the other employees to the target employee the number of times (the number of times of appearance together) that is less than the threshold.

Note that an experiment may be performed in advance, and the threshold may be set based on the experimental result. For example, an experiment may be performed to check whether or not the target employee thinks that he or she is not good at a task if the number of times that the target employee was given a request to perform the task and performed that task is less than a predetermined number of times, and the threshold may be set based on the experimental result.

For example, the motivator calculation unit 2 extracts, as the challenging field keyword group, a keyword that appeared together with a request term less than 20 times, but there is no limitation to this.

Next, the motivator calculation unit 2 acquires positional information of the target employee and utterance information and positional information of the other employees in the evaluation target period from Apr. 1, 2012 to Mar. 31, 2013, from the activity log storage unit 6 (step S23).

Then, the motivator calculation unit 2 counts a number of times A of appearance of the request term uttered to the target employee in each unit period (in each month) of the evaluation target period, based on the various types of information acquired in step S23 (step S24).

Furthermore, in step S24, the motivator calculation unit 2 counts a number of times D of appearance of a keyword contained in the challenging field keyword group together with the request term uttered to the target employee in each unit period, based on the various types of information acquired in step S23.

Then, the motivator calculation unit 2 calculates an appraisal/evaluation degree E, which is a value (D/A) obtained by dividing the number of times D of appearance of the keyword together with the request term by the number of times A of appearance of the request term in each month that is the unit period (step S25). In this manner, the motivator calculation unit 2 calculates an appraisal/evaluation degree for each month of the target period from Apr. 1, 2012 to Mar. 31, 2013.

Alternatively, the motivator calculation unit 2 may calculate an appraisal/evaluation degree in a manner as follows.

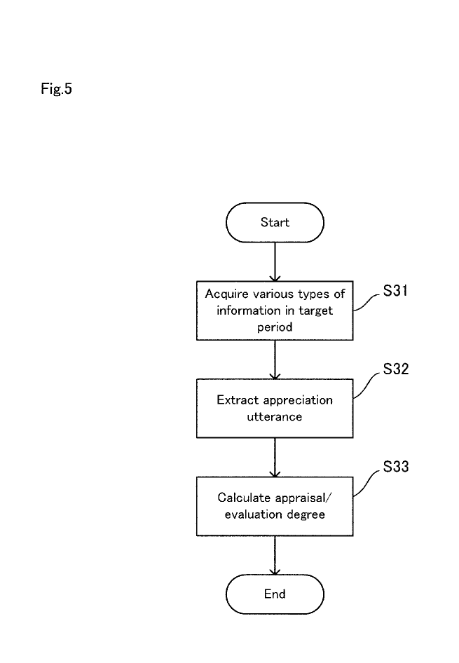

FIG. 5 is a flowchart showing another exemplary operation in which the motivation management device according to the embodiment of the present invention calculates an appraisal/evaluation degree.

In the example in FIG. 5, the motivator calculation unit 2 first acquires positional information of the target employee and utterance information and positional information of the other employees in the target period (step S31). For example, the motivator calculation unit 2 acquires the utterance information and the positional information in a period from Apr. 1, 2012 to Mar. 31, 2013, from the activity log storage unit 6 (step S31).

Next, the motivator calculation unit 2 extracts an appreciation utterance given to the target employee in each unit period, based on the utterance information and the positional information acquired in step S31 above (step S32). The appreciation utterance is a concept that encompasses a compliment, and examples thereof include words such as “thank you”, “it helped me”, and the like.

Then, the motivator calculation unit 2 counts a number of times that the appreciation utterance was given to the target employee, and obtains the number of times that the appreciation utterance was given, as the appraisal/evaluation degree, in each unit period (step S33).

The motivator calculation unit 2 can calculate an appraisal/evaluation degree using the various methods described above. Note that the motivator calculation unit 2 may use only an appraisal/evaluation degree calculated using any one method, or may use a combination of a plurality of appraisal/evaluation degrees as appropriate calculated using various methods.

Next, the process in which the motivator calculation unit 2 calculates a companionship degree will be specifically described.

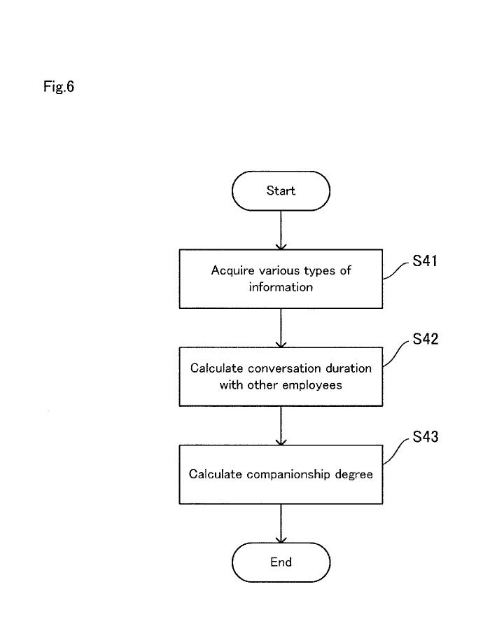

FIG. 6 is a flowchart showing an exemplary operation in which the motivation management device according to the embodiment of the present invention calculates a companionship degree.

As shown in FIG. 6, the motivator calculation unit 2 first acquires utterance information and positional information of the target employee and the other employees in the target period, from the activity log storage unit 6 (step S41). For example, the motivator calculation unit 2 acquires the utterance information and the positional information in a period from Apr. 1, 2012 to Mar. 31, 2013.

Next, the motivator calculation unit 2 calculates a conversation duration between the target employee and the other employees for each unit period, based on the utterance information and the positional information acquired from the activity log storage unit 6 in step S41 (step S42). For example, the motivator calculation unit 2 calculates a conversation duration between the target employee and the other employees for each month of the period from Apr. 1, 2012 to Mar. 31, 2013.

Then, the motivator calculation unit 2 calculates a companionship degree for each unit period, based on the conversation duration calculated in step S42 above (step S43). Specifically, the motivator calculation unit 2 calculates a proportion of other employees who had a conversation with the target employee for a duration that is a threshold or longer, with respect to all employees in the company to which the target employee belongs, and obtains this proportion as the companionship degree. For example, the motivator calculation unit 2 calculates a proportion of other employees who had a conversation with the target employee for one hour or longer, and obtains this proportion as the companionship degree. Note that there is no specific limitation on “proportion of other employees”, as long as it is a proportion in a group to which the target employee belongs. For example, “proportion of other employees” may be a proportion with respect to all employees in the department to which the target employee belongs.

Alternatively, the motivator calculation unit 2 may calculate a companionship degree, for example, in a manner as follows.

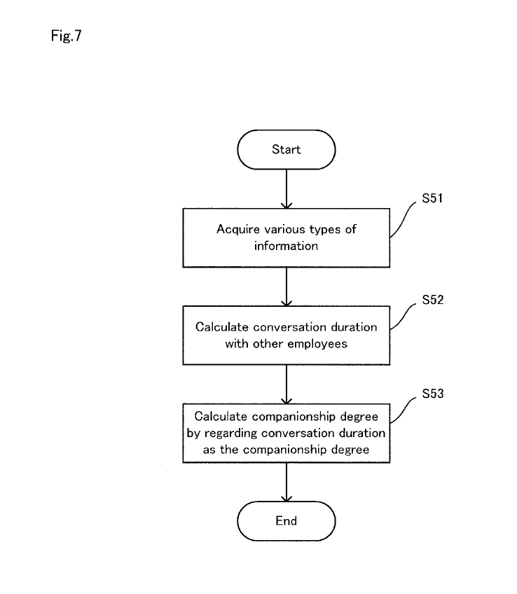

FIG. 7 is a flowchart showing another exemplary operation in which the motivation management device according to the embodiment of the present invention calculates a companionship degree.

As shown in FIG. 7, the motivator calculation unit 2 first acquires utterance information and positional information of the target employee and the other employees in the target period, from the activity log storage unit 6 (step S51). For example, the motivator calculation unit 2 acquires the utterance information and the positional information in a period from Apr. 1, 2012 to Mar. 31, 2013, from the activity log storage unit 6.

Next, the motivator calculation unit 2 calculates a conversation duration with the other employees for each unit period, based on the utterance information and the positional information acquired in step S51 (step S52). The motivator calculation unit 2 obtains the conversation duration, as the companionship degree, in each unit period (step S53).

Alternatively, the motivator calculation unit 2 may calculate a companionship degree in a manner as follows.

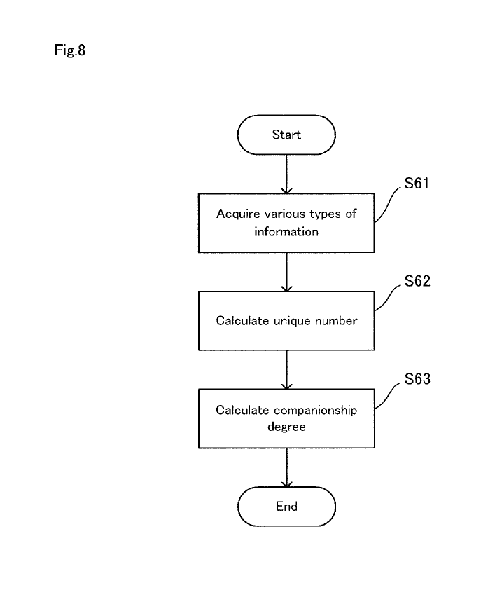

FIG. 8 is a flowchart showing another exemplary operation in which the motivation management device according to the embodiment of the present invention calculates a companionship degree.

As shown in FIG. 8, the motivator calculation unit 2 first acquires utterance information and positional information of the target employee and the other employees in the target period, from the activity log storage unit 6 (step S61). For example, the motivator calculation unit 2 acquires the utterance information and the positional information in a period from Apr. 1, 2012 to Mar. 31, 2013, from the activity log storage unit 6.

Next, the motivator calculation unit 2 calculates a unique number indicating the number of other employees who had a conversation with the target employee, for each unit period, based on the various types of information acquired in step S61 (step S62).

The motivator calculation unit 2 obtains the unique number, as the companionship degree, in each unit period (step S63).

The motivator calculation unit 2 can calculate a companionship degree using the various methods described above. Note that the motivator calculation unit 2 may use only a companionship degree calculated using any one method, or may use a combination of a plurality of companionship degrees as appropriate calculated using various methods.

Program

The program in the embodiment of the present invention may be a program for causing a computer to execute steps S1 to S5 shown in FIG. 2. If this program is installed in a computer and executed, the motivation management device 1 and the motivation management method in this embodiment can be realized. In this case, a central processing unit (CPU) of the computer performs processing by functioning as the motivator calculation unit 2, the motivation calculation unit 3, the relevance degree calculation unit 4, and the important motivator identification unit 5.

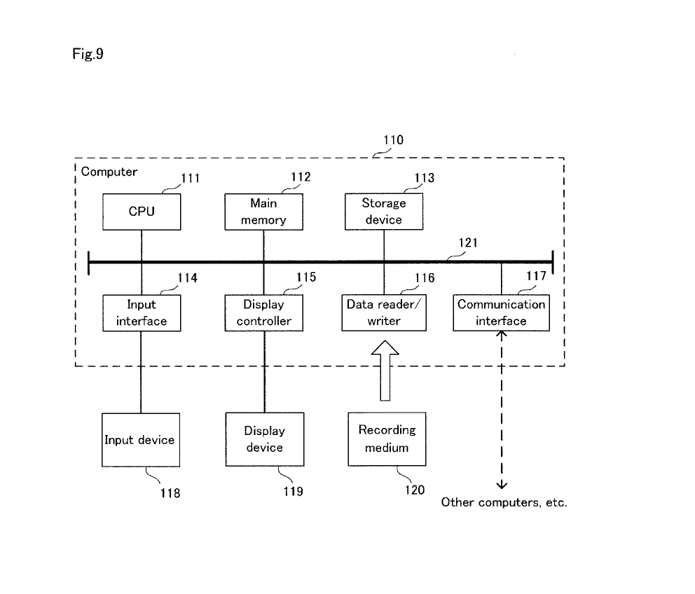

Hereinafter, the computer that realizes the motivation management device by executing the program in the embodiment will be described with reference to FIG. 9. FIG. 9 is a block diagram showing an exemplary computer that realizes the motivation management device according to the embodiment of the present invention.

As shown in FIG. 9, a computer 110 includes a CPU 111, a main memory 112, a storage device 113, an input interface 114, a display controller 115, a data reader/writer 116, and a communication interface 117. These units are data-communicably connected to each other via a bus 121.

The CPU 111 performs various types of operations by loading the programs (code) in this embodiment stored in the storage device 113 into the main memory 112, and executing these programs in a predetermined order. The main memory 112 is typically a volatile storage device such as a dynamic random access memory (DRAM) or the like. Furthermore, the program in this embodiment is provided in a form stored in a computer-readable recording medium 120. Note that the program in this embodiment may be distributed on the Internet connected via the communication interface 117.

Specific examples of the storage device 113 include, as well as a hard disk, a semiconductor storage device such as a flash memory. The input interface 114 mediates data transmission between the CPU 111 and an input device 118 such as a keyboard or a mouse. The display controller 115 is connected to a display device 119, and controls the display of the display device 119.

The data reader/writer 116 mediates data transmission between the CPU 111 and the recording medium 120, and reads a program from the recording medium 120 and writes a processing result in the computer 110 onto the recording medium 120. The communication interface 117 mediates data transmission between the CPU 111 and other computers.

Specific examples of the recording medium 120 include general-purpose semiconductor storage devices such as a CompactFlash (CF: registered trademark) and a Secure Digital (SD), magnetic storage media such as a flexible disk, and optical storage media such as a Compact Disc Read-Only Memory (CD-ROM).

In the description above, an embodiment of the present invention was described. However, the invention is not limited to the foregoing embodiment, and various modifications are possible within a range not departing from the gist of the invention.

For example, although the utterance information is acquired based on voice information input from a microphone or the like in the foregoing embodiment, the utterance information may be acquired from a mail log or the like.

Furthermore, part or the whole of the foregoing embodiment can be represented by Appendices 1 to 27 below, but there is no limitation to this.

Appendix 1

Appendix 1 is directed to a motivation management device, including:

a motivator calculation unit that acquires positional information of a target employee and other employees and utterance information of the target employee and the other employees, and calculates a degree of a motivator as a factor of a motivation of the target employee, based on the positional information and the utterance information;

a motivation calculation unit that calculates a degree of motivation of the target employee; and

a relevance degree calculation unit that calculates a relevance degree between the degree of the motivator and the degree of the motivation.

Appendix 2

The motivation management device according to Appendix 1 is such that the motivator calculation unit calculates degrees of a plurality of types of the motivators,

the relevance degree calculation unit calculates, for each of the motivators, a relevance degree between the degree of the motivator and the degree of the motivation, and

the motivation management device further includes: an important motivator identification unit that identifies a motivator that affects the motivation, as an important motivator, based on the relevance degree.

Appendix 3

The motivation management device according to Appendix 1 is such that the motivator calculation unit acquires the utterance information from one or both of voice information input to a microphone and a log of mails exchanged between the target employee and the other employees.

Appendix 4

The motivation management device according to Appendix 1 is such that the motivator calculation unit calculates a proportion of other employees who had a conversation with the target employee for a predetermined duration or longer, in a group to which the target employee belongs, based on the positional information and the utterance information, and calculates a companionship degree between the target employee and the other employees, as the degree of the motivator, based on the proportion.

Appendix 5

The motivation management device according to Appendix 1 is such that the motivator calculation unit calculates a conversation duration between the target employee and the other employees, based on the positional information and the utterance information, and calculates a companionship degree between the target employee and the other employees, as the degree of the motivator, based on the conversation duration.

Appendix 6

The motivation management device according to Appendix 1 is such that the motivator calculation unit calculates a unique number indicating the number of other employees who had a conversation with the target employee, based on the positional information and the utterance information, and calculates a companionship degree between the target employee and the other employees, as the degree of the motivator, based on the unique number.

Appendix 7

The motivation management device according to Appendix 1 is such that the motivator calculation unit extracts an appreciation utterance given to the target employee from the utterance information, and calculates an appraisal/evaluation degree indicating a degree of appraisal and evaluation toward the target employee, as the degree of the motivator, based on the number of times of appearance of the appreciation utterance.

Appendix 8

The motivation management device according to Appendix 1 is such that the motivator calculation unit extracts a keyword that appeared together with a request term uttered to the target employee the number of times that is a threshold or less, from utterance information in a predetermined period before a target period for calculation of the motivator, and calculates an appraisal/evaluation degree indicating a degree of appraisal and evaluation toward the target employee, as the degree of the motivator, based on the number of times of appearance of the keyword together with the request term in the target period.

Appendix 9

The motivation management device according to Appendix 1 is such that the motivator calculation unit extracts a keyword that appeared together with a request term uttered to the target employee the number of times that is a threshold or more, from utterance information in a predetermined period before a target period for calculation of the motivator, and calculates a job management degree indicating a degree of job management of the target employee, as the degree of the motivator, based on the number of times of appearance of the keyword together with the request term in the target period.

Appendix 10

Appendix 10 is directed to a method for managing a motivation of a target employee, including:

a step (a) of acquiring positional information of the target employee and other employees and utterance information of the target employee and the other employees;

a step (b) of calculating a degree of a motivator as a factor of the motivation of the target employee, based on the positional information and the utterance information;

a step (c) of calculating a degree of motivation of the target employee; and

a step (d) of calculating a relevance degree between the degree of the motivator and the degree of the motivation.

Appendix 11

The motivation management method according to Appendix 10 is such that, in the step (b), degrees of a plurality of types of the motivators are calculated,

in the step (c), for each of the motivators, a relevance degree between the degree of the motivator and the degree of the motivation is calculated, and

the motivation management method further includes: a step (e) of identifying a motivator that affects the motivation, as an important motivator, based on the relevance degree.

Appendix 12

The motivation management method according to Appendix 10 is such that, in the step (a), the utterance information is acquired from one or both of voice information input to a microphone and a log of mails exchanged between the target employee and the other employees.

Appendix 13

The motivation management method according to Appendix 10 is such that, in the step (b), a proportion of other employees who had a conversation with the target employee for a predetermined duration or longer, in a group to which the target employee belongs, is calculated based on the positional information and the utterance information, and a companionship degree between the target employee and the other employees is calculated as the degree of the motivator based on the proportion.

Appendix 14

The motivation management method according to Appendix 10 is such that, in the step (b), a conversation duration between the target employee and the other employees is calculated based on the positional information and the utterance information, and a companionship degree between the target employee and the other employees is calculated as the degree of the motivator based on the conversation duration.

Appendix 15

The motivation management method according to Appendix 10 is such that, in the step (b), a unique number indicating the number of other employees who had a conversation with the target employee is calculated based on the positional information and the utterance information, and a companionship degree between the target employee and the other employees is calculated as the degree of the motivator based on the unique number.

Appendix 16

The motivation management method according to Appendix 10 is such that, in the step (b), an appreciation utterance given to the target employee is extracted from the utterance information, and an appraisal/evaluation degree indicating a degree of appraisal and evaluation toward the target employee is calculated as the degree of the motivator based on the number of times of appearance of the appreciation utterance.

Appendix 17

The motivation management method according to Appendix 10 is such that, in the step (b), a keyword that appeared together with a request term uttered to the target employee the number of times that is a threshold or less is extracted from utterance information in a predetermined period before a target period for calculation of the motivator, and an appraisal/evaluation degree indicating a degree of appraisal and evaluation toward the target employee is calculated as the degree of the motivator based on the number of times of appearance of the keyword together with the request term in the target period.

Appendix 18

The motivation management method according to Appendix 10 is such that, in the step (b), a keyword that appeared together with a request term uttered to the target employee the number of times that is a threshold or more is extracted from utterance information in a predetermined period before a target period for calculation of the motivator, and a job management degree indicating a degree of job management of the target employee is calculated as the degree of the motivator based on the number of times of appearance of the keyword together with the request term in the target period.

Appendix 19

Appendix 19 is directed to a computer-readable recording medium in which a program for causing a computer to manage a motivation of a target employee is recorded, the program containing commands for causing the computer to execute:

a step (a) of acquiring positional information of the target employee and other employees and utterance information of the target employee and the other employees;

a step (b) of calculating a degree of a motivator as a factor of the motivation of the target employee, based on the positional information and the utterance information;

a step (c) of calculating a degree of motivation of the target employee; and

a step (d) of calculating a relevance degree between the degree of the motivator and the degree of the motivation.

Appendix 20

The computer-readable recording medium according to Appendix 19 is such that, in the step (b), degrees of a plurality of types of the motivators are calculated,

in the step (c), for each of the motivators, a relevance degree between the degree of the motivator and the degree of the motivation is calculated, and

the program further contains a command for causing the computer to execute: a step (e) of identifying a motivator that affects the motivation, as an important motivator, based on the relevance degree.

Appendix 21

The computer-readable recording medium according to Appendix 19 is such that, in the step (a), the utterance information is acquired from one or both of voice information input to a microphone and a log of mails exchanged between the target employee and the other employees.

Appendix 22

The computer-readable recording medium according to Appendix 19 is such that, in the step (b), a proportion of other employees who had a conversation with the target employee for a predetermined duration or longer, in a group to which the target employee belongs, is calculated based on the positional information and the utterance information, and a companionship degree between the target employee and the other employees is calculated as the degree of the motivator based on the proportion.

Appendix 23

The computer-readable recording medium according to Appendix 19 is such that, in the step (b), a conversation duration between the target employee and the other employees is calculated based on the positional information and the utterance information, and a companionship degree between the target employee and the other employees is calculated as the degree of the motivator based on the conversation duration.

Appendix 24

The computer-readable recording medium according to Appendix 19 is such that, in the step (b), a unique number indicating the number of other employees who had a conversation with the target employee is calculated based on the positional information and the utterance information, and a companionship degree between the target employee and the other employees is calculated as the degree of the motivator based on the unique number.

Appendix 25

The computer-readable recording medium according to Appendix 19 is such that, in the step (b), an appreciation utterance given to the target employee is extracted from the utterance information, and an appraisal/evaluation degree indicating a degree of appraisal and evaluation toward the target employee is calculated as the degree of the motivator based on the number of times of appearance of the appreciation utterance.

Appendix 26

The computer-readable recording medium according to Appendix 19 is such that, in the step (b), a keyword that appeared together with a request term uttered to the target employee the number of times that is a threshold or less is extracted from utterance information in a predetermined period before a target period for calculation of the motivator, and an appraisal/evaluation degree indicating a degree of appraisal and evaluation toward the target employee is calculated as the degree of the motivator based on the number of times of appearance of the keyword together with the request term in the target period.

Appendix 27

The computer-readable recording medium according to Appendix 19 is such that, in the step (b), a keyword that appeared together with a request term uttered to the target employee the number of times that is a threshold or more is extracted from utterance information in a predetermined period before a target period for calculation of the motivator, and a job management degree indicating a degree of job management of the target employee is calculated as the degree of the motivator based on the number of times of appearance of the keyword together with the request term in the target period.

In the description above, the present invention was described with reference to an embodiment. However, the invention is not limited to the foregoing embodiment, and the configuration and details of the invention can be modified in various ways that can be understood by those skilled in the art within the scope of the invention.

This application is based upon and claims the benefit of priority from Japanese Patent Application No. 2012-137422, filed on Jun. 19, 2012, and the entire contents of which are incorporated herein by reference.

### INDUSTRIAL APPLICABILITY

As described above, according to the present invention, an important motivator of the target employee can be identified. Thus, the present invention is useful for a personnel department of a company and the like.

### LIST OF REFERENCE NUMERALS

1 Motivation management device
2 Motivator calculation unit
3 Motivation calculation unit
4 Relevance degree calculation unit
5 Important motivator identification unit
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. A motivation management device, comprising:
a motivator calculation unit that acquires positional information of a target employee and other employees and utterance information of the target employee and the other employees, and calculates a degree of a motivator as a factor of a motivation of the target employee, based on the positional information and the utterance information;
a motivation calculation unit that calculates a degree of motivation of the target employee; and
a relevance degree calculation unit that calculates a relevance degree between the degree of the motivator and the degree of the motivation.

2. The motivation management device, according to claim 1,
wherein the motivator calculation unit calculates degrees of a plurality of types of the motivators,
the relevance degree calculation unit calculates, for each of the motivators, a relevance degree between the degree of the motivator and the degree of the motivation, and
the motivation management device further comprises: an important motivator identification unit that identifies a motivator that affects the motivation, as an important motivator, based on the relevance degree.

3. The motivation management device, according to claim 1, wherein the motivator calculation unit acquires the utterance information from one or both of voice information input to a microphone and a log of mails exchanged between the target employee and the other employees.

4. The motivation management device, according to claim 1, wherein the motivator calculation unit calculates a proportion of other employees who had a conversation with the target employee for a predetermined duration or longer, in a group to which the target employee belongs, based on the positional information and the utterance information, and calculates a companionship degree between the target employee and the other employees, as the degree of the motivator, based on the proportion.

5. The motivation management device, according to claim 1, wherein the motivator calculation unit calculates a conversation duration between the target employee and the other employees, based on the positional information and the utterance information, and calculates a companionship degree between the target employee and the other employees, as the degree of the motivator, based on the conversation duration.

6. The motivation management device, according to claim 1, wherein the motivator calculation unit calculates a unique number indicating the number of other employees who had a conversation with the target employee, based on the positional information and the utterance information, and calculates a companionship degree between the target employee and the other employees, as the degree of the motivator, based on the unique number.

7. The motivation management device, according to claim 1, wherein the motivator calculation unit extracts an appreciation utterance given to the target employee from the utterance information, and calculates an appraisal/evaluation degree indicating a degree of appraisal and evaluation toward the target employee, as the degree of the motivator, based on the number of times of appearance of the appreciation utterance.

8. The motivation management device, according to claim 1, wherein the motivator calculation unit extracts a keyword that appeared together with a request term uttered to the target employee the number of times that is less than a threshold, from utterance information in a predetermined period before a target period for calculation of the motivator, and calculates an appraisal/evaluation degree indicating a degree of appraisal and evaluation toward the target employee, as the degree of the motivator, based on the number of times of appearance of the keyword together with the request term in the target period.

9. The motivation management device, according to claim 1, wherein the motivator calculation unit extracts a keyword that appeared together with a request term uttered to the target employee the number of times that is a threshold or more, from utterance information in a predetermined period before a target period for calculation of the motivator, and calculates a job management degree indicating a degree of job management of the target employee, as the degree of the motivator, based on the number of times of appearance of the keyword together with the request term in the target period.

10. A method for managing a motivation of a target employee, comprising:
a step (a) of acquiring positional information of the target employee and other employees and utterance information of the target employee and the other employees;
a step (b) of calculating a degree of a motivator as a factor of the motivation of the target employee, based on the positional information and the utterance information;
a step (c) of calculating a degree of motivation of the target employee; and
a step (d) of calculating a relevance degree between the degree of the motivator and the degree of the motivation.

11. The motivation management method, according to claim 10,
wherein, in the step (b), degrees of a plurality of types of the motivators are calculated,
in the step (c), for each of the motivators, a relevance degree between the degree of the motivator and the degree of the motivation is calculated, and
the motivation management method further comprises: a step (e) of identifying a motivator that affects the motivation, as an important motivator, based on the relevance degree.

12. The motivation management method, according to claim 10, wherein, in the step (a), the utterance information is acquired from one or both of voice information input to a microphone and a log of mails exchanged between the target employee and the other employees.

13. The motivation management method, according to claim 10, wherein, in the step (b), a proportion of other employees who had a conversation with the target employee for a predetermined duration or longer, in a group to which the target employee belongs, is calculated based on the positional information and the utterance information, and a companionship degree between the target employee and the other employees is calculated as the degree of the motivator based on the proportion.

14. The motivation management method, according to claim 10, wherein, in the step (b), a conversation duration between the target employee and the other employees is calculated based on the positional information and the utterance information, and a companionship degree between the target employee and the other employees is calculated as the degree of the motivator based on the conversation duration.

15. The motivation management method, according to claim 10, wherein, in the step (b), a unique number indicating the number of other employees who had a conversation with the target employee is calculated based on the positional information and the utterance information, and a companionship degree between the target employee and the other employees is calculated as the degree of the motivator based on the unique number.

16. The motivation management method, according to claim 10, wherein, in the step (b), an appreciation utterance given to the target employee is extracted from the utterance information, and an appraisal/evaluation degree indicating a degree of appraisal and evaluation toward the target employee is calculated as the degree of the motivator based on the number of times of appearance of the appreciation utterance.

17. The motivation management method, according to claim 10, wherein, in the step (b), a keyword that appeared together with a request term uttered to the target employee the number of times that is less than a threshold is extracted from utterance information in a predetermined period before a target period for calculation of the motivator, and an appraisal/evaluation degree indicating a degree of appraisal and evaluation toward the target employee is calculated as the degree of the motivator based on the number of times of appearance of the keyword together with the request term in the target period.

18. The motivation management method, according to claim 10, wherein, in the step (b), a keyword that appeared together with a request term uttered to the target employee the number of times that is a threshold or more is extracted from utterance information in a predetermined period before a target period for calculation of the motivator, and a job management degree indicating a degree of job management of the target employee is calculated as the degree of the motivator based on the number of times of appearance of the keyword together with the request term in the target period.

19. A computer-readable recording medium in which a program for causing a computer to manage a motivation of a target employee is recorded, the program containing commands for causing the computer to execute:
a step (a) of acquiring positional information of the target employee and other employees and utterance information of the target employee and the other employees;
a step (b) of calculating a degree of a motivator as a factor of the motivation of the target employee, based on the positional information and the utterance information;
a step (c) of calculating a degree of motivation of the target employee; and
a step (d) of calculating a relevance degree between the degree of the motivator and the degree of the motivation.

20. The computer-readable recording medium according to claim 19,
wherein, in the step (b), degrees of a plurality of types of the motivators are calculated,
in the step (c), for each of the motivators, a relevance degree between the degree of the motivator and the degree of the motivation is calculated, and
the program further contains a command for causing the computer to execute: a step (e) of identifying a motivator that affects the motivation, as an important motivator, based on the relevance degree.

21. The computer-readable recording medium according to claim 19, wherein, in the step (a), the utterance information is acquired from one or both of voice information input to a microphone and a log of mails exchanged between the target employee and the other employees.

22. The computer-readable recording medium according to claim 19, wherein, in the step (b), a proportion of other employees who had a conversation with the target employee for a predetermined duration or longer, in a group to which the target employee belongs, is calculated based on the positional information and the utterance information, and a companionship degree between the target employee and the other employees is calculated as the degree of the motivator based on the proportion.

23. The computer-readable recording medium according to claim 19, wherein, in the step (b), a conversation duration between the target employee and the other employees is calculated based on the positional information and the utterance information, and a companionship degree between the target employee and the other employees is calculated as the degree of the motivator based on the conversation duration.

24. The computer-readable recording medium according to claim 19, wherein, in the step (b), a unique number indicating the number of other employees who had a conversation with the target employee is calculated based on the positional information and the utterance information, and a companionship degree between the target employee and the other employees is calculated as the degree of the motivator based on the unique number.

25. The computer-readable recording medium according to claim 19, wherein, in the step (b), an appreciation utterance given to the target employee is extracted from the utterance information, and an appraisal/evaluation degree indicating a degree of appraisal and evaluation toward the target employee is calculated as the degree of the motivator based on the number of times of appearance of the appreciation utterance.

26. The computer-readable recording medium according to claim 19, wherein, in the step (b), a keyword that appeared together with a request term uttered to the target employee the number of times that is less than a threshold is extracted from utterance information in a predetermined period before a target period for calculation of the motivator, and an appraisal/evaluation degree indicating a degree of appraisal and evaluation toward the target employee is calculated as the degree of the motivator based on the number of times of appearance of the keyword together with the request term in the target period.

27. The computer-readable recording medium according to claim 19, wherein, in the step (b), a keyword that appeared together with a request term uttered to the target employee the number of times that is a threshold or more is extracted from utterance information in a predetermined period before a target period for calculation of the motivator, and a job management degree indicating a degree of job management of the target employee is calculated as the degree of the motivator based on the number of times of appearance of the keyword together with the request term in the target period.
